(19) United States
(12) Patent Application Publication
(10) Pub. No.: US 2008/0316858 A1
(43) Pub. Date: Dec. 25, 2008

(54) Oscillatory Flow Mixing Reactor

(75) Inventors: Heidi Gron, Maintal (DE); Rudiger Schutte, Alzenau (DE); Karlheinz Drauz, Freigericht (DE); Klaus Stadtmuller, Alzenau (DE); James Ian Grayson, Durham City (GB)

Correspondence Address: OBLON, SPIVAK, MCCLELLAND MAIER & NEUSTADT, P.C., 1940 DUKE STREET, ALEXANDRIA, VA, 22314, US

(73) Assignee: DEGUSSA GMBH, Duesseldorf (DE)

(21) Appl. No.: 11/817,164

(22) PCT Filed: Feb. 13, 2006
(86) PCT No.: PCT/EP06/50887

§ 371 Date: Jan. 25, 2008

(30) Foreign Application Priority Data
Mar. 1, 2005 (DE) 10 2005 009 322.1

(51) Int. Cl. B01F 3/00; B01J 19/24

(52) U.S. Cl. 366/341; 422/224

(57) ABSTRACT

The present invention relates to an oscillatory flow mixing reactor (OPM) oscillatory flow which is designed so that a flow with angular momentum is superposed by means effecting circular acceleration on the mixture flowing in with oscillation, with the result that good mixing of the individual phases of the mixture is achieved with the use of low shear forces. A use of the reactor according to the invention is also disclosed.

The present invention relates to a reactor which is suitable for the particularly thorough mixing of two or more substances which are separated from one another by a phase boundary. In particular, the reactor according to the invention is to be used for the thorough mixing of a liquid phase with at least one further liquid, solid or gaseous phase.

The mixing of heterogeneous phase mixtures in which a liquid phase is in contact with a further liquid, solid or gaseous phase is an area of chemical process engineering which receives a great deal of attention. Inter alia, so-called “oscillatory baffled reactors”, called OBRs for short, are known in this context. In the case of said reactors, a pulsed stream of a heterogenous multiphase mixture is passed through a flow tube, the flow of the mixture being opposed by centrally perforated baffles at certain distances. As a result of the confrontation of the flow with the baffles, vortexes form in the mixture and permit more or less thorough mixing of the multiphase mixture (EP631809; WO9955457; EP540180).

In addition to the systems described here, WO8700079 describes an embodiment in FIG. 3 which represents the design of a flow tube through which a pulsed stream of a heterogeneous mixture can be passed. Instead of the baffles described above, a helix produced from a metal ribbon is present here in the flow tube, which helix is fixed on one side to the wall of the flow tube and points on the other side to the open middle of the flow tube. According to the teaching of this document, it is essential for the ribbon forming the coaxially placed helix to have a sharp-edged surface geometry pointing towards the middle of the flow tube. It is necessary either for the metal ribbon to be very thin or for the end forming the inner edge of the metal ribbon to be sharpened. According to the document under discussion here, this is supposed to lead to as thorough mixing as possible of the heterogeneous mixture.

It was an object of the present invention to provide a further method which makes it possible to mix heterogeneous phase mixtures particularly thoroughly. In contrast to the embodiments of the prior art, the procedure according to the invention should be suitable for avoiding dead zones in the reactor and for subjecting the mixture to be dispersed to the minimum possible shear stress. It should be capable of being integrated flexibly into existing production plants and should be superior to the known methods from the economical point of view.

This and further objects not specified but arising in an obvious manner from the prior art are achieved by a method having the features of Claim 1 relating to the subject matter. Claims 2 and 3 relate to preferred embodiments of the reactor according to the invention. Claim 4 relates to a use thereof.

Because, in a mixing reactor through which a flow of a gas/liquid, liquid/liquid or liquid/solid mixture oscillating in the longitudinal direction of the reactor is passed, having at least one means attached to the wall and effecting the circular acceleration of this mixture at right angles to the longitudinal direction once said mixture flows through the reactor in one direction and reversal of the circular acceleration of this mixture when the mixture flows through the reactor in the other direction, said means has a flattened surface geometry, a very advantageous achievement of the object is obtained, which is to be classified as surprising in the light of the prior art. It is precisely the flattened geometry of the means close to the wall in the reactor which, in association with the oscillating flow of the mixture through said means, permits excellent mixing of said mixture with simultaneous avoidance of dead zones which, in the converse case, would lead to undesired deposits from the mixture. At the same time, the particular profile results in only minimum shear stress on the mixture, which, for example in the case of enzymatic reactions, is decisive for increasing the duration of activity of the sensitive enzymes involved.

In contrast to WO8700079, in the present case the means present for giving rise to the circular acceleration in the mixture flowing through the reactor with pulsation are not sharp-edged, as required there, but flattened. Flattening in the context of the present invention means that a geometry of the means which tapers towards the inside of the reactor and ends with a sharp edge is not meant. The maximum height of the means should be ≦0.2×d, where d denotes the internal diameter of the reactor at the location of the means considered. Preferably, the height of the means is ≦0.14×d, particularly preferably ≦0.12×d and very particularly preferably ≦0.10×d. This results in a free flow-through area of the total apparatus cross section of >50%. Within these limits, the flow-through area can be easily adapted by the person skilled in the art helped by optimization experiments according to the circumstances present. The geometry of the means considered here can be freely chosen by the person skilled in the art as part of the measures discussed above. Semicircular, tetragonal or polygonal embodiments are particularly suitable. It should be ensured that the angle between reactor wall and protuberance/channel (positioning angle α; FIG. 1) does not exceed 90° on both sides. An angle α of from 30 to 80°, is preferred, particularly preferably from 50 to 70°.

The flow of the phases to be mixed through the reactor takes place in an oscillating manner according to the methods of the prior art (J. Harris, G. Peev, W. L. Wilkinson: Velocity profiles in laminar oscillatory flow in tubes, Journal of Scientific Instruments (Journal of Physics E), Series 2, Volume 2, 1969). It has been found that pulsation of the flow with an amplitude of 0.02×d-1.00×d, preferably 0.05×d-0.5×d, particularly preferably 0.10×d-0.2×d and very particularly preferably of 0.13×d (±0.2) is suitable for mixing. The frequency of the pulsation may be in the range from 0.5 to 50 Hz, preferably from 1 to 10 Hz and particularly preferably from 6.5 Hz (±3 Hz).

The mixture may consist of any desired gas/liquid, liquid/liquid or liquid/solid mixture. Owing to the low shear force introduced into said mixture, the apparatus according to the invention is particularly suitable for those mixtures which have mechanically sensitive constituents. These are in particular relatively high molecular weight compounds, preferably in the area of biomolecules such as proteins, nucleic acids, etc. Precisely for the mixing of enzyme dispersions, crystal suspensions liable to break or drop size-sensitive gas/liquid reaction media, the reactor according to the invention is therefore particularly suitable. Suitable liquid phases are both all organic and inorganic liquid, provided that the reactor material is inert to them.

The at least one means which is arranged statically on the inner wall of the reactor which imparts circular acceleration at right angles to the direction of flow (=longitudinal direction) to the mixture flowing through the reactor is known to the person skilled in the art. Said means are preferably planks which are fastened to the inside of the reactor and against which the flow is appropriately deflected on contact. The means for circular acceleration of the mixture is preferably a protuberance of the reactor wall, which protuberance is wound helically in the longitudinal direction, or a channel in the reactor wall, which channel is wound helically in the longitudinal direction, or the two alternately. It is not necessary for the abovementioned protuberance or channel to be present continuously through the reactor. Rather, it is also possible to establish these means only in sections. For reasons relating to apparatus technology, however, it may be advantageous to arrange the means discussed continuously through the reactor.

The slope of the means discussed in the reactor (γ; FIG. 1) should preferably be between 30 and 85°, more preferably between 40 and 80° and very particularly preferably between 50 and 70° in order to achieve optimum mixing of the phases. Depending on the requirements of the mixing task, the slope of the means may be constant, progressive or degressive.

The reactor according to the invention can be designed according to the concepts of the person skilled in the art. An inflow through which the reactor is fed with the mixture and an outflow through which the mixture can be removed from the reactor must be present. The reactor geometry may be based on the underlying mixing problem in each case [e.g. reactors, evaporators or crystallizers with free or forced circulation]. The use of a flow tube as a reactor is very particularly preferred. Such a flow tube is shown in FIG. 1. The diameter of the tube can be chosen as desired by the person skilled in the art according to the intended use. Thin reactors, for example used in bundles, may have smaller tube diameters of up to 25 μm. There is no upper limit for the person skilled in the art, but flow tubes having a diameter up to 1.0 m are preferably suitable for mixing. More preferred are tube diameters of from 0.5 mm to 0.5 m and very particularly preferably from 0.5 cm to 20 cm.

The mixing reactors according to the invention can be equipped with the equipment customary for standard reactors. They can be operated with cooling or heating or be designed in such a way that superatmospheric pressure can be employed in them. The person skilled in the art is familiar with the manner in which reactors thus designed have to be assembled [E. B. Nauman: Chemical Reactor Design, Optimization, and Scale-up, McGraw-Hill, 2002].

In a subsequent development, the present invention relates to the use of a mixing reactor as described above for mixing a liquid phase with at least one further liquid, solid or gaseous phase in contact therewith across a phase boundary. It is to be regarded as an apparatus for the process intensification of multiphase reaction, mixing, precipitation and/or crystallization systems. The reactor is preferably used in systems which contain a mixture which has sensitive biomolecules, such as, for example, proteins.

As already indicated above, plug flow with excellent micromixing and optimum radial mixing can be produced by means of the mixing reactor according to the invention, even in the case of very flat profiles close to the wall (so-called helices), which are preferably arched (cf. FIG. 1). This functions particularly well in the case of low volume flows (laminar base flow) and small amplitudes of the high-frequency pulsation (Re_{oscillation}=2 Reₗₐₘᵢₙₐᵣ; cf. FIG. 2). The formation of so-called dead zones and hence the probability of the formation of deposits from the mixture can be avoided to a very considerable extent. At the same time, through dispersing of the mixture with minimal shear stress takes place. Through its compact design and the possibility of being able to use it flexibly, the reactor according to the invention helps to cut the capital costs and operating costs. It produces products having defined product properties and is easy to clean.

### EXAMPLE

### Cooling Crystallization and Aggregation of a Growth-Inhibited Organic Substance

The crystal growth of the organic substance A is limited. In order to achieve the required particle size (>200 μm) of this solid product, the primary crystals formed (about 10 μm) must be aggregated in a controlled manner. This requires thorough mixing at relatively low shear stresses. Thorough mixing leads to controlled crystal formation and to a multiplicity of particle-particle collisions which lead with a certain probability to aggregation of the particles. A shear stress on the other hand leads to undesired disintegration of the aggregates. In order to achieve an economical yield of this process step, long residence times have to be realized which strengthens the requirement for gentle mixing.

Conventionally, this product is produced by continuous cooling crystallization in a stirred container. A disadvantage is that the long residence time results in the aggregates formed being destroyed again by the stirring member, which produces very high shear stresses close to the stirrer blade. In the stirred vessel, however, a stirring member is required for mixing in order to avoid concentration and temperature gradients in the stirred container and thus to ensure homogeneous elimination of supersaturation. A further disadvantage of the stirred container is the resulting very broad residence time distribution, which leads to a particle size distribution which is broad to an undesired extent.

A suitable reactor embodiment for such a process requirement (production output about 8 l/h) is shown in FIG. 3.

The reactor consists of a plurality of tubes which are provided with heating or cooling jackets (each 1.70 m long) and are connected to one another via insulated arcs. Each individual reactor tube can be separately thermostatted. Consequently, a chosen temperature profile is permitted for controlled cooling crystallization with subsequent aggregation of the primary crystals formed. In the case of a reactor length of about 12 m it is possible to establish a residence time of about 3 h, which is sufficient for realizing the required particle size. The aggregation is promoted by the mixing which is thorough but does not impose shear stress with the result that the required particle sizes are achieved.

### DESCRIPTION OF THE DRAWINGS

FIG. 1:

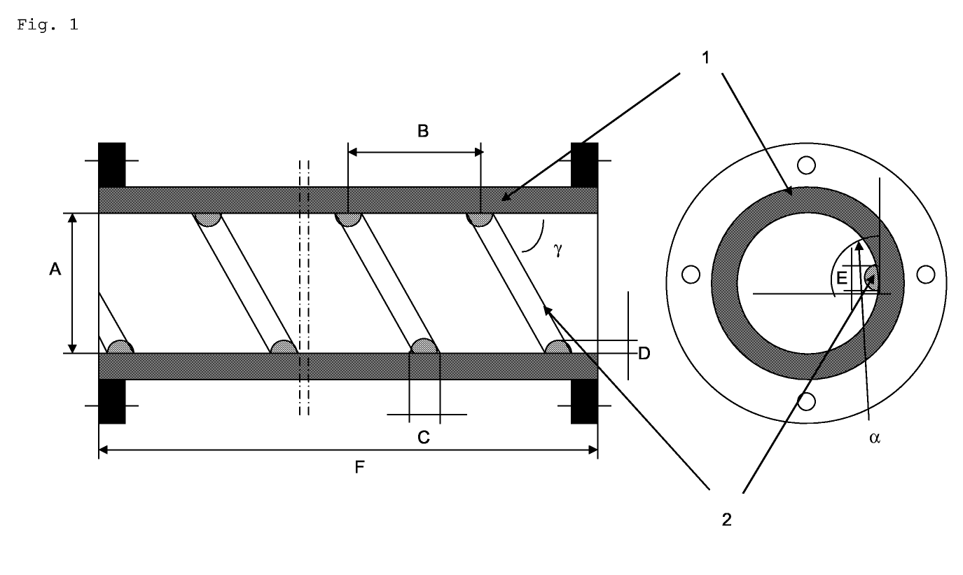

Preferred embodiment of a reactor according to the invention. In a tubular apparatus through which laminar flow of a liquid takes place, plug flow free of dead space is generated by superposing a pulsation on a flow with angular momentum. 1 denotes the inner wall of the reactor, and 2 denotes the profiles (helices) close to the wall. Preferred relative dimensions of the system are A with 43 mm, B with 40 mm, C with 4 mm and D with 3 mm. F should be dimensioned according to requirements.

FIG. 2:

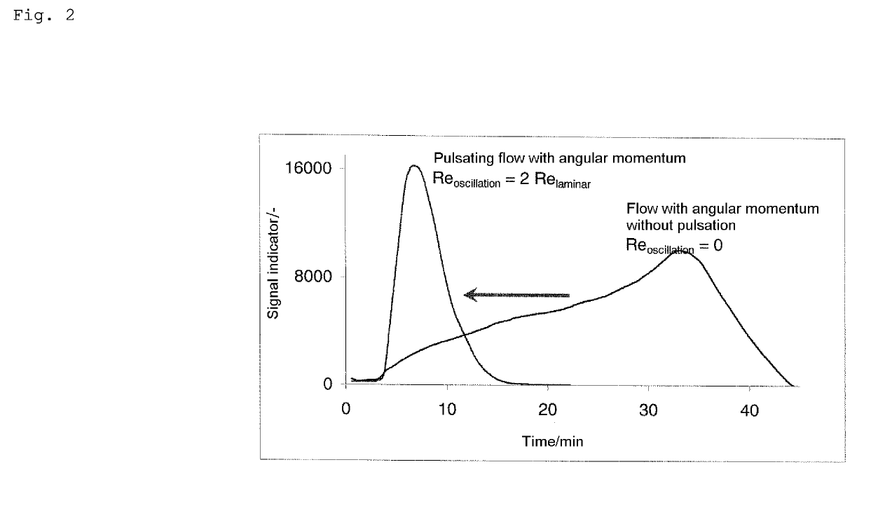

Residence time distributions in the reactor in the case of simple flow with angular momentum (Re_{oscillation}=0) and in the case of superposed pulsation flow with angular momentum (Re_{oscillation}=2 Reₗₐₘᵢₙₐᵣ).

FIG. 3:

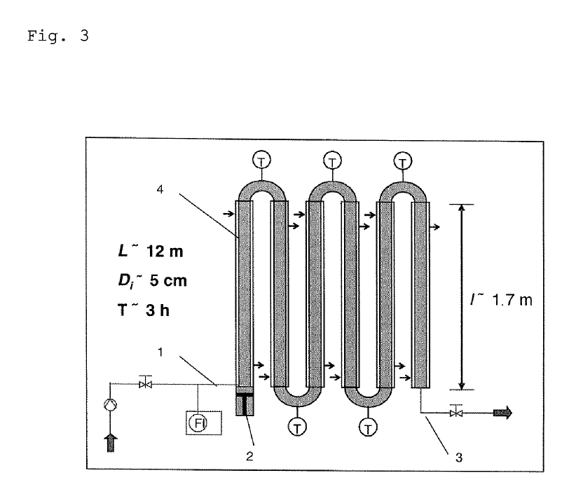

Embodiment of a reactor according to the invention for continuous cooling crystallization and aggregation of a growth-inhibited organic substance. The reactor is designed for a production rate of 8 l/h.

The phase mixture is fed to the reactor via the feed 1. An oscillation is superposed thereon by means of the ram 2 so that the phase mixture flows slowly through the attached reactor parts 4 by a forward and backward movement. The phase mixture leaves the reactor in mixed form via the outlet 3.

1. Mixing reactor, through which a flow of a gas/liquid, liquid/liquid or liquid/solid mixture oscillating in the longitudinal direction of the reactor is passed, having at least one means attached to the wall effecting the circular acceleration of this mixture at right angles to the longitudinal direction once said mixture flows through the reactor in one direction and reversal of the circular acceleration of this mixture when the mixture flows through the reactor in the other direction characterized in that said means has a flattened surface geometry.

2. Reactor according to claim 1, characterized in that the means for circular acceleration of the mixture constitutes a protuberance of the reactor wall, which protuberance is wound helically in the longitudinal direction, or a channel in the reactor wall, which channel is wound helically in the longitudinal direction, or the two alternately.

3. Reactor according to claim 1, characterized in that the reactor is a flow tube.

4. Use of a mixing reactor according to claim 1 for mixing a liquid phase with at least one further liquid, solid or gaseous phase in contact therewith across a phase boundary.
